(19) United States
(12) Patent Application Publication
(10) Pub. No.: US 2010/0270008 A1
(43) Pub. Date: Oct. 28, 2010

(54) In-Line Heat Exchange Cleaning System For Liquid Processing Systems

(75) Inventor: Zvi Livni, Tel Aviv (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: C.Q.M. LTD., Tirat Yehuda (IL)

(21) Appl. No.: 11/668,005

(22) Filed: Jan. 29, 2007

(51) Int. Cl. F28G 1/00; B08B 9/00

(52) U.S. Cl. 165/95; 134/166 R

(57) ABSTRACT

An inline heat-exchanger cleaning system for an industrial production process employs liquid-borne cleaning bodies carried by the process liquid. Various solutions are provided to render the cleaning bodies compatible with a range of process conditions, including acidic conditions, high temperatures, and specific gravities significantly higher and significantly lower than water.

### FIELD AND BACKGROUND OF THE INVENTION

The present invention relates to industrial production processes including heat exchangers and, in particular, it concerns processing system and method including an inline heat-exchanger cleaning system with liquid-borne cleaning bodies carried by the process liquid.

In the field of heat exchangers employing water or seawater as a working liquid, it is known to employ ball-cleaning systems. Examples of these systems and their components may be found in U.S. Pat. Nos 5,388,636; 5,450,895; 5,447,193; and 6,91.3,071, all co-assigned with the present application, which are hereby incorporated by reference in their entirety. In general terms, these systems provide a large number of cleaning bodies, typically sponge balls, which are injected into the working liquid upstream of the heat exchanger and trapped on the downstream side of the heat exchanger. The balls are sized so that they just fit through the fine tubes of the heat exchanger, scraping away deposits and dirt as they go. This ensures that efficiency of heat exchange is maintained while avoiding most of the costly down-time which would otherwise be required for frequent cleaning of the heat exchanger.

Although these techniques are well established in applications using water and seawater as a working liquid, for example, in power stations, this technology has not previously been applied, to the best of the inventor's knowledge, for cleaning a heat exchanger through which a process liquid passes as part of a manufacturing process. As a result, the reduction in heat-exchange efficiency and consequent energy losses due to build up of scale and other deposits in heat exchangers account for a significant part of the manufacturing costs of a wide range of different products and their derivatives.

One obstacle to implementation of such cleaning systems as part of a manufacturing process is the limited range of densities available. In most cases, the materials commonly used for the aforementioned sponge balls only offer a small range of densities, and in particular, will float to the top of a process liquid significantly denser than water.

A further obstacle to implementations of such cleaning systems are the chemical and physical operating conditions under which the system must operate. Many production processes operate under highly acidic conditions. For example, multistage evaporators are frequently used in phosphoric acid plants to increase the concentration of dilute phosphoric acid to 52-55 wt % P₂O₅. The concentrated phosphoric acid solution is supersaturated with respect to calcium sulfate. As a result, part of the calcium sulfate in the liquor deposits on the heat exchanger tube walls. Since the thermal conductivity of these scales is very low, thin deposits can create a significant resistance to heat transfer. Therefore, regular cleaning of heat exchangers is required, frequently at less than biweekly intervals. As the major costs in modern phosphoric acid plants are the cost of energy, both the reduction in heat-exchange efficiency and the down-time for cleaning are critical factors in the cost efficiency of the production process. However, the acidic conditions and high specific gravity of the process liquid are not conducive to adoption of the rubber sponge ball systems commonly used in power stations.

Another set of examples are processing of petrochemicals, such as “cracking”. Cracking of petrochemicals is typically performed at pressures of up to 220 atmospheres and temperatures of around 500 degrees Celsius. These temperatures prohibit the use of polymer balls of the type described above.

There is therefore a need for liquid processing systems which would incorporate inline cleaning systems in which liquid-borne bodies clean tubes of a heat exchanger. It would also be particularly advantageous to provide heat exchanger cleaning systems and corresponding cleaning bodies suited to a range of liquid densities and operating conditions which would facilitate their use in a wide range of industrial processes.

### SUMMARY OF THE INVENTION

The present invention is a liquid processing system and method including an inline heat-exchanger cleaning system with liquid-borne cleaning bodies carried by the process liquid.

According to the teachings of the present invention there is provided, a system for processing a process liquid to generate from the process liquid a product, the system comprising (a) a liquid processing arrangement including a heat exchanger having a plurality of heat exchange pipes of given internal diameter, the liquid processing arrangement being configured to generate a flow of the process liquid through the heat exchange pipes; and (b) a cleaning subsystem associated with the liquid processing arrangement, the cleaning subsystem including a plurality of liquid-borne cleaning bodies sized to pass through the plurality of heat exchange pipes in frictional contact with an internal surface of the plurality of heat exchange pipes, thereby cleaning the plurality of heat exchange pipes.

According to a further feature of the present invention, the cleaning subsystem further includes a cleaning body injector deployed for injecting the plurality of cleaning bodies into the process liquid upstream of the heat exchanger.

According to a further feature of the present invention, the cleaning subsystem further includes a cleaning body trap deployed for removing the plurality of cleaning bodies from the process liquid downstream of the heat exchanger.

According to a further feature of the present invention, the cleaning bodies are substantially spherical.

According to a further feature of the present invention, the cleaning bodies are formed primarily from polymer material.

According to a further feature of the present invention, the polymer material is chemically stable under acidic conditions with a pH less then 4.

According to a further feature of the present invention, the polymer material includes silicone rubber.

According to a further feature of the present invention, the process liquid has a specific gravity greater than 1, and wherein each of the cleaning bodies includes an insert formed from a material of density greater than a density of the polymer material.

According to a further feature of the present invention, the insert is formed from metallic material.

According to a further feature of the present invention, the insert is formed from a material resistant to corrosion under acidic conditions with a pH less than 4.

According to a further feature of the present invention, the insert is sealed within the polymer material.

According to a further feature of the present invention, an effective buoyancy of the polymer material together with the insert corresponds to a specific gravity of 1.4±02.

According to a further feature of the present invention, the liquid processing arrangement is part of a production process for an acid.

According to a further feature of the present invention, the cleaning bodies are formed primarily from at least one elongated metallic element.

According to a further feature of the present invention, the at least one elongated metallic element is at least one elongated metallic ribbon.

According to a further feature of the present invention, the at least one elongated metallic element is implemented as a plurality of elongated metallic elements intertwined to form a cohesive mass.

According to a further feature of the present invention, the at least one elongated metallic element is shaped to lie primarily within a given wall thickness of a hollow spherical form.

According to a further feature of the present invention, the at least one elongated metallic element is shaped to lie primarily on the surface of a spherical shape.

According to a further feature of the present invention, the at least one elongated metallic element occupies no more than about five percent of an effective body volume for each cleaning body.

According to a further feature of the present invention, the liquid processing arrangement is part of a hydrocarbon cracking process.

According to a further feature of the present invention, the liquid processing arrangement generates process liquid temperatures in excess of 400 degrees Celsius.

There is also provided according to the teachings of the present invention, a cleaning element for use entrained in a flow of a liquid having a specific gravity greater than 11, the cleaning body comprising: (a) a body formed from polymer material, the body having a generally spherical shape and being formed with a bore; and (b) an insert formed from material significantly more dense than the polymer material, the insert being shaped for insertion into the bore, thereby imparting to the cleaning element a predefined effective density.

According to a further feature of the present invention, the body is formed with at least one resilient retaining feature configured to retain the insert in position within the bore.

According to a further feature of the present invention, the insert is formed from a metal or metal alloy.

### BRIEF DESCRIPTION OF THE DRAWINGS

The invention is herein described, by way of example only, with reference to the accompanying drawings, wherein.

FIGS. 1A and 1B are a schematic views of a cleaning system for cleaning a heat exchanger suitable for implementing the present invention, the cleaning system being illustrated during a cleaning element injection step and a cleaning element retrieval step, respectively,

FIG. 2 is an isometric view of a first preferred external form of a cleaning body, constructed and operative according to the teachings of the present invention,

FIG. 3A is a cross-sectional view taken through a second preferred external form of a cleaning body, constructed and operative according to the teachings of the present invention;

FIG. 3B is a side view of the cleaning body of FIG. 3A;

FIG. 3C is a top view of the cleaning body of FIG. 3A;

FIG. 4 is a cross-sectional view illustrating a first implementation of a density-modified cleaning body, constructed and operative according to the teachings of the present invention;

FIG. 5 is a cross-sectional view illustrating a second implementation of a density-modified cleaning body, constructed and operative according to the teachings of the present invention;

FIG. 6 is a schematic illustration of an implementation of a cleaning body formed from intertwined elongated metallic elements, constructed and operative according to the teachings of the present invention;

FIG. 7 is a schematic illustration of an implementation of a cleaning body similar to that of FIG. 6 where the metallic elements are localized to a spherical shell; and

FIG. 8 is a schematic illustration of a further implementation of a cleaning body formed from an elongated metallic element, constructed and operative according to the teachings of the present invention, lying substantially on the surface of a sphere.

### DESCRIPTION OF THE PREFERRED EMBODIMENTS

The present invention is a liquid processing system and method including an inline heat-exchanger cleaning system with liquid-borne cleaning bodies carried by the process liquid.

The principles and operation of systems and methods according to the present invention may be better understood with reference to the drawings and the accompanying description.

In general terms, the present invention provides a system for processing a process liquid to generate a product therefrom. The system includes a liquid processing arrangement including a heat exchanger having a plurality of heat exchange pipes of given internal diameter, and generates a flow of the process liquid through the heat exchange pipes. The details of the liquid processing arrangement depend upon the nature of the process to which the present invention is applied, and do not per se constitute part of the present invention. A first preferred subcategory of production processes for which the invention is believed to be particularly advantageous are processes for manufacturing, concentrating or otherwise employing high concentrations of acids. A second subcategory of production processes for which the invention is believed to be particularly advantageous are processes performed at high temperatures on petrochemicals, such as cracking. In each case, details of the processes themselves will only be addressed herein to the extent that they are directly relevant to the features of the present invention, while other features well known in the respective fields of technology will be omitted for conciseness.

The present invention supplements the liquid processing arrangement with a cleaning subsystem including a plurality of liquid-borne cleaning bodies sized to pass through the plurality of heat exchange pipes in frictional contact with an internal surface of the plurality of heat exchange pipes, thereby cleaning the plurality of heat exchange pipes. Thus, in contrast to the water or sea-water implementations mentioned above, the cleaning bodies of the present invention are temporarily entrained within, and then removed from, the flow of the process liquid from which a manufactured product is derived.

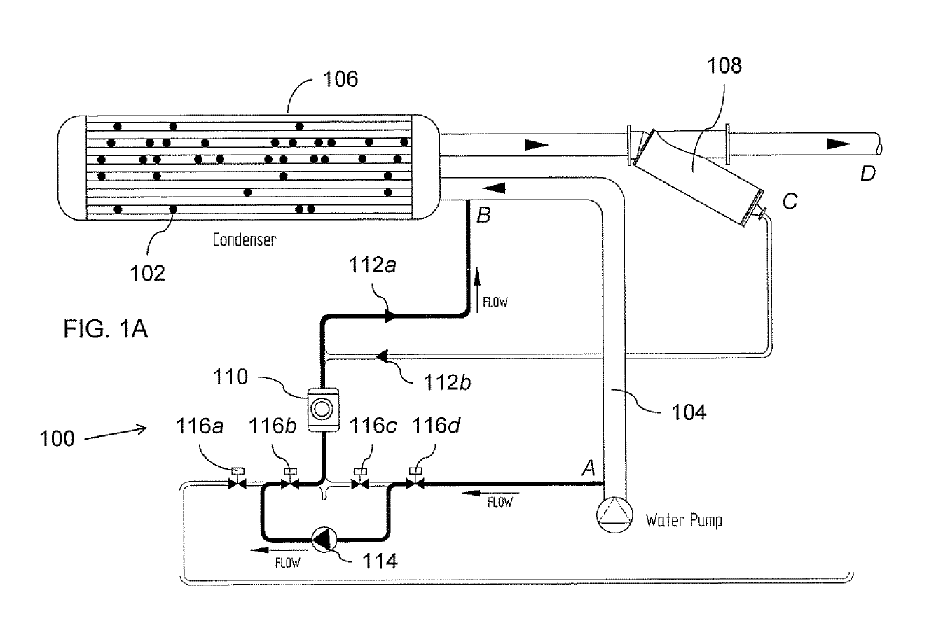

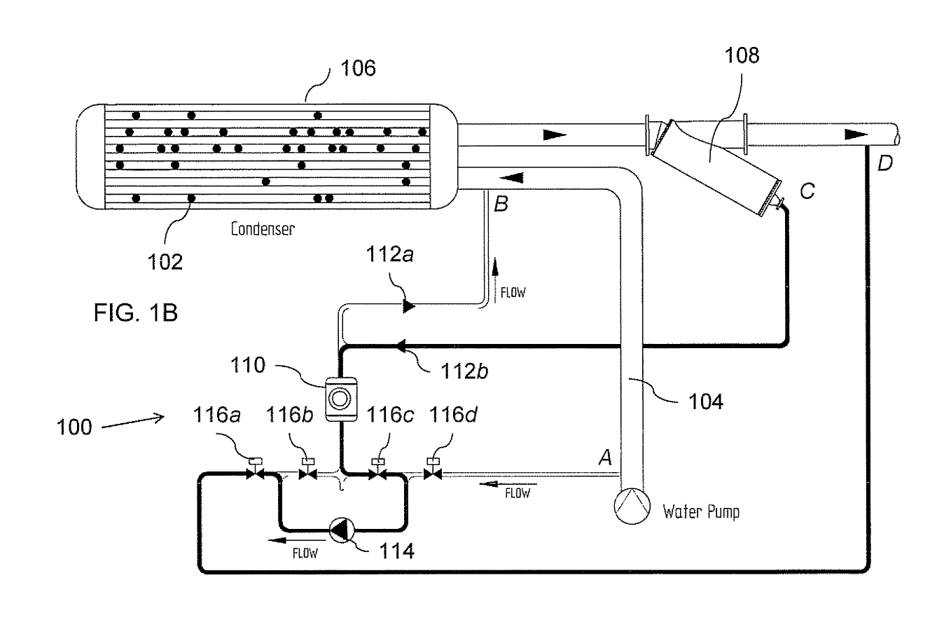

Referring now to the drawings, FIGS. 1A and 1B show a non-limiting example of a system, generally designated 100, for injecting and retrieving cleaning bodies 102 into and from a primary flow path 104 including a heat exchanger 106. The cleaning subsystem preferably includes a cleaning body injector system deployed for injecting cleaning bodies 102 into the process liquid upstream of heat exchanger 106, and a cleaning body trap 108 deployed for removing the plurality of cleaning bodies from the process liquid downstream of the heat exchanger.

The cleaning body injector system includes a cleaning body storage housing 110, unidirectional check valves 112a and 112b, a pump 114 and four control valves 116a, 116b, 116c and 116d. The injector system connects to primary flow path 104 at four locations, denoted by letters A, B, C and D. In the state of FIG. 1A, control valves 116b and 116d are open and 116a and 116c are closed so that pump 114 pumps liquid from A to B, thereby injecting the cleaning elements from storage housing 110 into the primary flow path at B, upstream from the heat exchanger 106. A short while later, after the cleaning bodies have all passed through the heat exchanger and have been caught in trap 108, the system switches to the state of FIG. 1B. In this state, control valves 116a and 116c are open and 116b and 116d are closed. As a result, pump 114 draws liquid from trap retrieval port C through storage housing 110, thereby accumulating the cleaning bodies back into their storage location where they are stopped by a sieve arrangement. The flow from C is then returned to the primary flow path at D.

Further details of how to implement technical aspects of the injector and trap of the present invention for a wide range of applications will be apparent on the basis of these drawings, and the disclosure of the patent documents incorporated by reference above. Suitable choices of materials, dimensions and other design parameters will be chosen according to the physical and chemical operating conditions of the intended application, all as will be clear to a person having ordinary skill in the art. For conciseness of presentation, further detailed description of the structure and operation of the system of FIGS. 1A and 1B is omitted here.

As mentioned above, the specific preferred features of the present invention, and particularly, the preferred implementations for the cleaning bodies, will be exemplified with reference to two subcategories of production processes for which the invention is believed to be particularly advantageous highly acidic production processes; and high temperature petrochemical processing. These two subcategories will now be addressed separately. It should be appreciated, however, that many of the features described in the context of these examples are equally applicable to other applications, as will be clear to one ordinarily skilled in the art.

### Acidic Production Processes

The primary distinctive features of this subcategory of production processes relate to design of the cleaning bodies 10 to be suited both to the chemical environment and range of densities of the process liquid.

Most preferably, the cleaning bodies for these applications are formed primarily from polymer materials chosen for their chemical stability under acidic conditions. Particularly preferred is silicone rubber which is substantially unaffected by even concentrated acid conditions, for example, with pH less than 4, and even significantly lower.

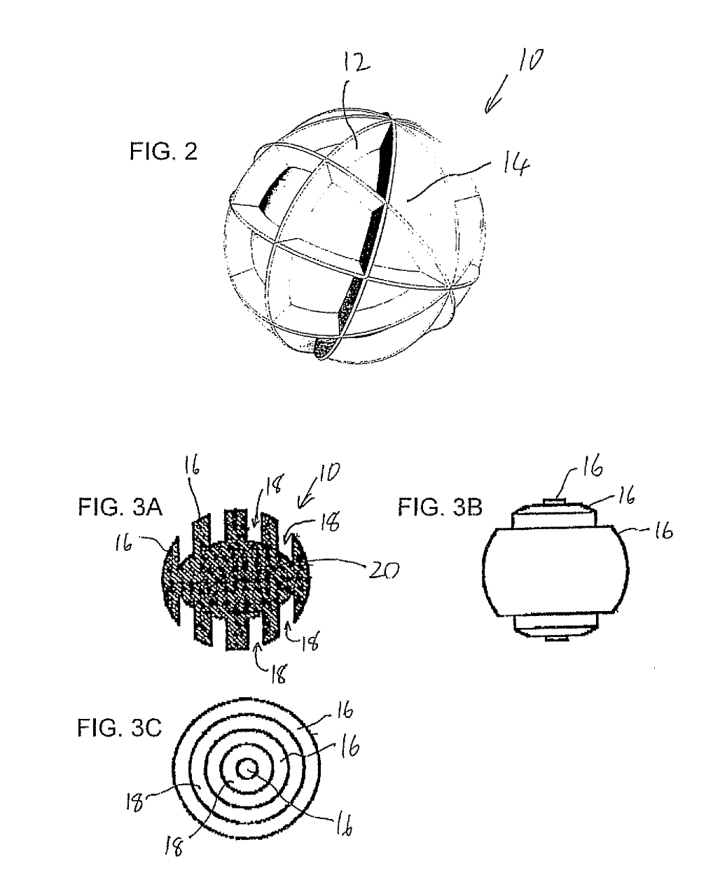

Substantially spherical forms are preferred. In order to impart a desired degree of flexibility to the structure, the outer surface of cleaning bodies 10 is preferably provided with various patterns of ribs or other flexible features. One such pattern is illustrated in FIG. 2, in which radially projecting ridges 12 extend around the diameter of a spherical core 14 in various different directions, providing a substantially spherical overall footprint. The ridges 12 serve as wiper blades for rubbing the internal surfaces of the heat exchanger tubes.

An alternative external form for cleaning bodies 10 is illustrated in FIGS. 3A-3C. In this case, a generally spherical external shape is modified by concentric cylindrical slots 18 from two opposite sides of the body, forming between them a concentric pattern of ridges 16. The depth of slots 18 define the thickness of a central core 20. The depth, width and number of slots 18, and the corresponding dimensions of ridges 16, define the degree of flexibility of the resulting structure.

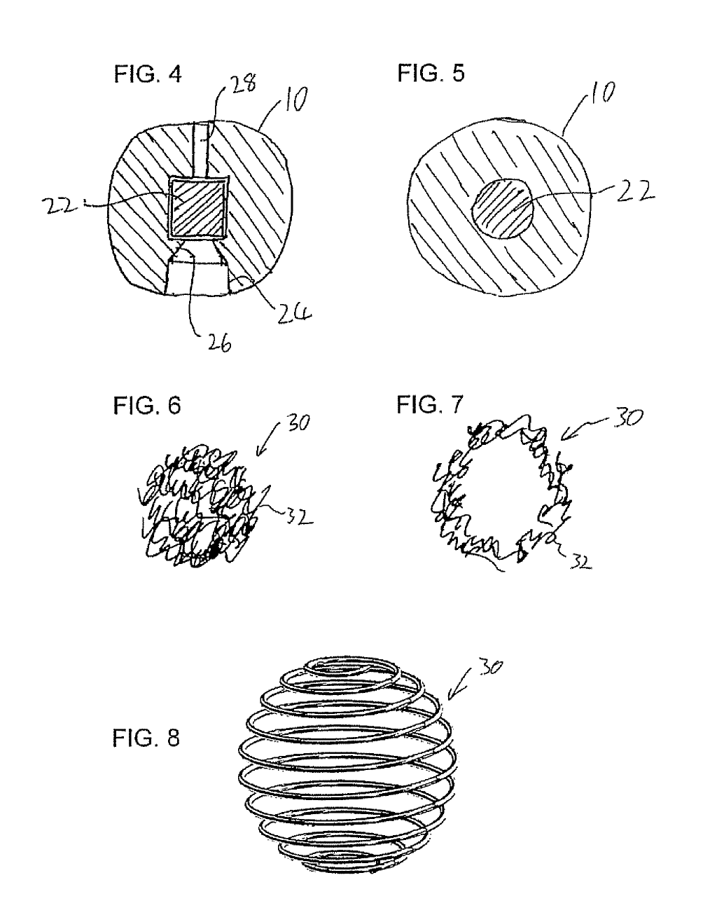

Turning now to FIGS. 4 and 5, these illustrate structures and corresponding methods for achieving a desired level of buoyancy (effective specific gravity) so that the cleaning bodies 10 are effectively entrained in the process liquid flow. Specifically, as noted above, many process liquids, particularly in the productions of concentrated solutions or solids, reach a specific gravity (relative to water) in the range of 1.2 up to 16. The polymer materials used for cleaning bodies are typically of specific gravity around 1 or less, i.e, less dense than water. As a result, steps are needed to ensure that the cleaning bodies don't float to the top of the process liquid and fail to perform their intended function. To this end, each of cleaning bodies 10 preferably includes an insert 22 formed from a material of density greater than a density of the polymer material. Typically, insert 22 is formed from metallic material.

One implementation of this principle is represented in FIG. 4. In this case, cleaning body 10 is formed with a bore 24 for receiving insert 22. In the preferred case shown here, bore 24 is formed with resilient retaining features, here shown as barbed projections 26. Cleaning body 10 is initially formed with bore 24 as shown, and then insert 22 is forcibly inserted, passing barbed projections 26 and becoming permanently locked into position as shown. In some cases, an additional vent hole 28 is provided to ensure that trapped air within the bore doesn't oppose insertion of insert 22. Alternatively, a small channel along one side of bore 24 may perform a similar function.

It will be noted that insert 22 as shown in FIG. 4 is exposed to the process liquid of the system. As a result, the material of insert 22 is chosen to be resistant to corrosion under the working conditions of the processing system, and in our case, under acidic conditions with a pH less than 4. One non-limiting example of a suitable material is a stainless steel insert.

FIG. 5 illustrates an alternative approach in which insert 22 is sealed within the polymer material as a fully-enclosed inner core. This structure can be achieved by inserting suitably sized metal particles into the soft material prior to final forming of the outer structure by known production techniques, such as press molding. One advantage of this approach is that insert 22 is completely enveloped in the polymer material and is not exposed to the process liquid. This allows the use of low cost materials, such as iron, as a weight without risk of corrosion.

Parenthetically, it should be noted that the implementations of FIGS. 4 and 5 may be combined with the external forms of FIG. 2 or 3A-3C, or any other external form, and are shown here schematically with smooth outer surfaces for simplicity of description.

By suitable choice of the size and material of insert 22, cleaning bodies 10 may be configured to provide substantially any effective specific gravity greater than that of the polymer material. Thus, in the set of applications referred to above, an effective buoyancy of the polymer material together with the insert may advantageously be brought to values corresponding to a specific gravity of 1.4±0.2. Optionally, a set of different inserts 22, for example, hollow cylindrical inserts of differing wall thicknesses, may fit within the same outer body, thereby providing a modular manufacturing process in which a single polymer body may be used with inserts selected from a range of different weights to achieve a required effective buoyancy on demand.

### High Temperature Petrochemical Processing

As mentioned above, processes in the subcategory, and in a preferred example, hydrocarbon cracking processes, often operate at temperatures in excess of 400 degrees Celsius for which suitable polymer materials are not available. Instead, according to the teachings of the present invention, cleaning bodies 30 for these applications are formed primarily from at least one elongated metallic element 32. Although the density of the metallic material is much greater than that of the petrochemical liquids, by employing elongated thin elements, such as wire, thin ribbon or the like, the ratio of surface area to mass can be made sufficiently high to ensure that the cleaning body 30 is entrained in the liquid flow by drag forces. Specifically, the sum total of the elongated metallic element(s) 32 preferably occupies no more than about five percent of an effective body volume for each cleaning body 30, and more typically no more than 1-2 percent.

According to one particularly preferred optional implementation, the at least one elongated metallic element is at least one elongated metallic ribbon. Suitable “ribbon” includes helically-coiled fine metal shavings. These shavings, typically available at low price as a natural byproduct of metal machining, are known for use in various scouring and domestic cleaning products, and can readily be intertwined (tangled) to form a cohesive mass of a desired approximate shape. Typically, the preferred shape is, once again, approximating to a spherical ball as shown in FIG. 6. Alternatively, a similar effect may be obtained by using a structure colloquially referred to as a “pompom”, namely, where a large number of strands or coils of metal are tied or otherwise fixed together at a central position and radiate roughly spherically therefrom.

FIG. 7 illustrates a further option for cleaning body 30 generally similar to that of FIG. 6 but in which the at least one elongated metallic element is shaped to lie primarily within a given wall thickness of a hollow spherical form, i.e., in a spherical shell.

Turning finally to FIG. 8, this illustrates a yet further option for implementation of cleaning body 30 in which the body is formed by an elongated metallic element, in this case a resilient pre-shaped wire, shaped to lie primarily on the surface of a sphere. In alternative terminology, this implementation may be considered a spherical or “ball-shaped” variant of a helical spring. This option also maintains the preferred combination of properties, namely, high surface area to mass ratio, spherical effective outer shape and resilience.

It will be appreciated that the above descriptions are intended only to serve as examples, and that many other embodiments are possible within the scope of the present invention as defined in the appended claims.

What is claimed is:

1. A system for processing a process liquid to generate from the process liquid a product, the system comprising:
(a) a liquid processing arrangement including a heat exchanger having a plurality of heat exchange pipes of given internal diameter, said liquid processing arrangement being configured to generate a flow of the process liquid through said heat exchange pipes; and
(b) a cleaning subsystem associated with said liquid processing arrangement, said cleaning subsystem including a plurality of liquid-borne cleaning bodies sized to pass through said plurality of heat exchange pipes in frictional contact with an internal surface of said plurality of heat exchange pipes, thereby cleaning said plurality of heat exchange pipes.

2. The system of claim 1, wherein said cleaning subsystem further includes a cleaning body injector deployed for injecting said plurality of cleaning bodies into the process liquid upstream of said heat exchanger.

3. The system of claim 2, wherein said cleaning subsystem further includes a cleaning body trap deployed for removing said plurality of cleaning bodies from the process liquid downstream of said heat exchanger.

4. The system of claim 1, wherein said cleaning bodies are substantially spherical.

5. The system of claim 1, wherein said cleaning bodies are formed primarily from polymer material.

6. The system of claim 5, wherein said polymer material is chemically stable under acidic conditions with a pH less then 4.

7. The system of claim 5, wherein said polymer material includes silicone rubber.

8. The system of claim 5, wherein said process liquid has a specific gravity greater than 1, and wherein each of said cleaning bodies includes an insert formed from a material of density greater than a density of said polymer material.

9. The system of claim 8, wherein said insert is formed from metallic material.

10. The system of claim 8, wherein said insert is formed from a material resistant to corrosion under acidic conditions with a pH less than 4.

11. The system of claim 8, wherein said insert is sealed within said polymer material.

12. The system of claim 8, wherein an effective buoyancy of said polymer material together with said insert corresponds to a specific gravity of 14±02.

13. The system of claim 12, wherein said liquid processing arrangement is part of a production process for an acid.

14. The system of claim 1, wherein said cleaning bodies are formed primarily from at least one elongated metallic element.

15. The system of claim 14, wherein said at least one elongated metallic element is at least one elongated metallic ribbon.

16. The system of claim 14, wherein said at least one elongated metallic element is implemented as a plurality of elongated metallic elements intertwined to form a cohesive mass.

17. The system of claim 14, wherein said at least one elongated metallic element is shaped to lie primarily within a given wall thickness of a hollow spherical form.

18. The system of claim 14, wherein said at least one elongated metallic element is shaped to lie primarily on the surface of a spherical shape.

19. The system of claim 14, wherein said at least one elongated metallic element occupies no more than about five percent of an effective body volume for each cleaning body.

20. The system of claim 14, wherein said liquid processing arrangement is part of a hydrocarbon cracking process.

21. The system of claim 14, wherein said liquid processing arrangement generates process liquid temperatures in excess of 400 degrees Celsius.

22. A cleaning element for use entrained in a flow of a liquid having a specific gravity greater than 11, the cleaning body comprising:
(a) a body formed from polymer material, the body having a generally spherical shape and being formed with a bore, and
(b) an insert formed from material significantly more dense than said polymer material, said insert being shaped for insertion into said bore, thereby imparting to the cleaning element a predefined effective density.

23. The cleaning element of claim 22, wherein said body is formed with at least one resilient retaining feature configured to retain said insert in position within said bore.

24. The cleaning element of claim 22, wherein said insert is formed from a metal or metal alloy.
